(19) United States
(12) Patent Application Publication
(10) Pub. No.: US 2026/0044901 A1
(43) Pub. Date: Feb. 12, 2026

(54) Integrated Market for Investors, Job-Seekers, and Startups

(71) Applicant: Jefferson Willey, Columbia, MD (US)

(72) Inventor: Jefferson Willey, Columbia, MD (US)

(21) Appl. No.: 14/679,975

(22) Filed: Apr. 6, 2015

Related U.S. Application Data
(60) Provisional application No. 61/975,902, filed on Apr. 6, 2014.

(51) Int. Cl. G06Q 40/06; G06Q 10/1053

(52) U.S. Cl. CPC G06Q 40/068; G06Q 10/1053

(57) ABSTRACT

An employment investment process includes providing a performer database and populating the performer database with performer data. The performer data includes data related to job description, employment term, and/or minimum salary of an individual performer. An employer database is provided and populated with data related to available position, intended projects, and credit rating of an individual employer. A performer pledge account is assigned to the individual performer. Investors are enabled to pledge monetary funds to the performer pledge account. The performer is employed by the employer when the pledged monetary funds reach the minimum salary. The performer's salary is paid to the performer from the performer pledge account until the end of the employment term. An investment amount is paid to the investors by the employer.

### CROSS-REFERENCE TO RELATED APPLICATION

This is related to and claims priority from U.S. Provisional Application Patent No. 61/975,902, which was filed on Apr. 6, 2014, the disclosure of which is incorporated herein in its entirety.

### FIELD OF THE INVENTION

The present invention relates to a market for investors, job-seekers, and employers, including startups. In particular, the invention relates to a market that provides jobs, funding, and investment opportunities and matches compatible participants for mutual benefit.

### BACKGROUND OF THE INVENTION

For a startup beginning a new venture, or an established company looking to expand, there are many options for raising capital. Friends and Family, angel investors, and venture capitalists can provide early capital to get a business off the ground, or to help a company expand. The company being funded needs the money to hire employees, and the investors are looking to make a healthy return on the investment to justify the risk being taken. Potential employees also benefit from such funding and the opportunity provided when like-minded employers and investors come together. Likewise, investors feel mare confident in providing capital if they know that a skilled workforce will be employed as a result of the investment, and if they have an idea of the creditworthiness of the employer.

In an attempt to streamline the process of providing capital for businesses, crowd-funding entities have emerged which try to bring companies and investors together by providing information about and promoting startups. This information is provided to potential investors of all levels, in the hope that an investment goal can be reached even by aggregating the capital of a large number of small investors.

While there are many crowd-funding avenues for startups, none of them allow the startup to establish the terms for the rate of return on a loan. Further, no funding sources are available by which investors can pledge funds for the future contract or employment of individual potential employees. In addition, no current crowd-funding entity allows potential employees to publically set and display their own minimum salary requirements in an effort to compete for jobs in the startup market, or any other employment market. Bringing together employers, job performers, and investors in a single, transparent market would be very beneficial for all players in the market.

### BRIEF SUMMARY OF THE INVENTION

According to an aspect of the invention, an employment investment process includes providing a performer database and populating the performer database with performer data. The performer data includes data related to job description, employment term, and/or minimum salary of an individual performer. An employer database is provided and populated with data related to available position, intended projects, and credit rating of an individual employer. A performer pledge account is assigned to the individual performer. Investors are enabled to pledge monetary funds to the performer pledge account. The performer is employed by the employer when the pledged monetary funds reach the minimum salary. The performer's salary is paid to the performer from the performer pledge account until the end of the employment term. An investment amount is paid to the investors by the employer.

The performer data can also include data related to work history, education, training, credentials, licenses, certifications, geographical area, and/or available equipment of the individual performer.

The process can also include conditioning the investor's pledge based on any one or more items of the performer data.

The process can also include generating the credit rating of the individual employer by a third party entity.

The performer pledge account can be associated with a depository of the pledged monetary funds. In this case, the process can also include depositing the pledged monetary funds into the depository by the investor at or after the time that the funds are pledged. Preferably, interest is paid on the deposited pledged funds by an affiliated bank to the investor.

The process can also include corresponding the individual performer's job description with the available position of the individual employer.

The process can also include conditioning the investor's pledge based on the individual employer's credit rating. Conditioning the investor's pledge can include, for example, assigning a minimum employer credit rating to any pledge of monetary funds.

The process can also include monitoring the pledged funds until the minimum salary is reached, and confirming employment of the performer by the employer. Employment of the performer by the employer can be confirmed, for example, automatically when the funds pledged by all investors reach the minimum salary for the employment term. Alternatively, employment of the performer by the employer can be confirmed by assent of the performer, employer, and investors when the pledged funds reach the minimum salary. Preferably, the investors are allowed to withdraw the pledged funds from the performer pledge account if the employment of the performer by the employee is not yet confirmed. The performer can then be employed by the employer after the employment is confirmed. A salary is paid to the performer from the performer pledge account when the performer is employed. For example, the performer's salary can be paid in periodic increments. The process can also include preparing a report regarding the performer's employment and providing the report to the investor.

The investment amount can be paid to the investors by the employer at the end of the employment term. The investment amount can be, for example, a predetermined percentage of the pledged monetary funds. Alternatively, the investment amount can be a predetermined fixed monetary amount.

The employer can be a business startup or an outside employer. The process can include assigning an employer pledge account to the employer. In this case, a minimum funding amount, an investor interest rate, and/or a risk assessment score can be associated with the employer pledge account. Investors can be enabled to pledge monetary funds to the employer pledge account.

The process can include providing a plurality of the performer databases. Each performer database is associated with a respective individual performer. A plurality of the employer databases are provided. Each employer database is associated with a respective individual employer. A performer pledge account is assigned to each individual performer. Investors are enabled to pledge monetary funds to one or more of the performer pledge accounts. One of the performers is employed by one of the employers when the pledged monetary funds for the one performer reach the minimum salary associated with the one performer. The one performer's salary is paid from the performer pledge account until the end of the employment term. An investment amount is paid to the investors by the one employer.

Enabling investors to pledge monetary funds to one or more of the performer pledge accounts can include enabling an investor to pledge the monetary funds such that the funds are distributed among a subset of the plurality of performers. For example, the subset can be selected based at least in part on data included in the performer databases, such as at least in part on the credit ratings of plurality of employers.

The process can also include offering membership to an organization to the performers, the investors, and the employers, and restricting the process to the performers, the investors, and the employers who are members of the organization. At least some information related to the pledged monetary funds, the salaries, the performer data, and the credit ratings can be made available to members of the organization. In some cases, data users who are not performers, investors, or employees can be allowed to become members of the organization.

### BRIEF DESCRIPTION OF THE DRAWINGS

FIG. 1 is a diagram of an exemplary embodiment of the system.

FIGS. 2-7 show exemplary aspects of the process of the invention.

FIG. 8 is a tabular depiction of an exemplary performer pledge account.

FIG. 9 shows an exemplary time history of a performer's pledge account.

FIG. 10 shows a performer's pledge account viewed as pledge amount vs. color of money.

FIG. 11 is an exemplary investor's view of his system account.

FIG. 12 is a table showing an exemplary top-level view of a performer database.

FIG. 13 is a table showing an exemplary top-level view of a startup database.

### DETAILED DESCRIPTION OF THE INVENTION

The invention is a process and system that brings investors, employers, and potential employees together streamlining and making efficient the task of providing a workforce for an employer such as a startup company while finding funding to pay that workforce. At the same time, investors have an opportunity to earn returns on invested funds. The entire operation is transparent, providing a level of confidence to all parties regarding the desired outcome of any transaction. In this way it is analogous to a dating service for business entities, helping to match like-minded participants based on information provided for each participant.

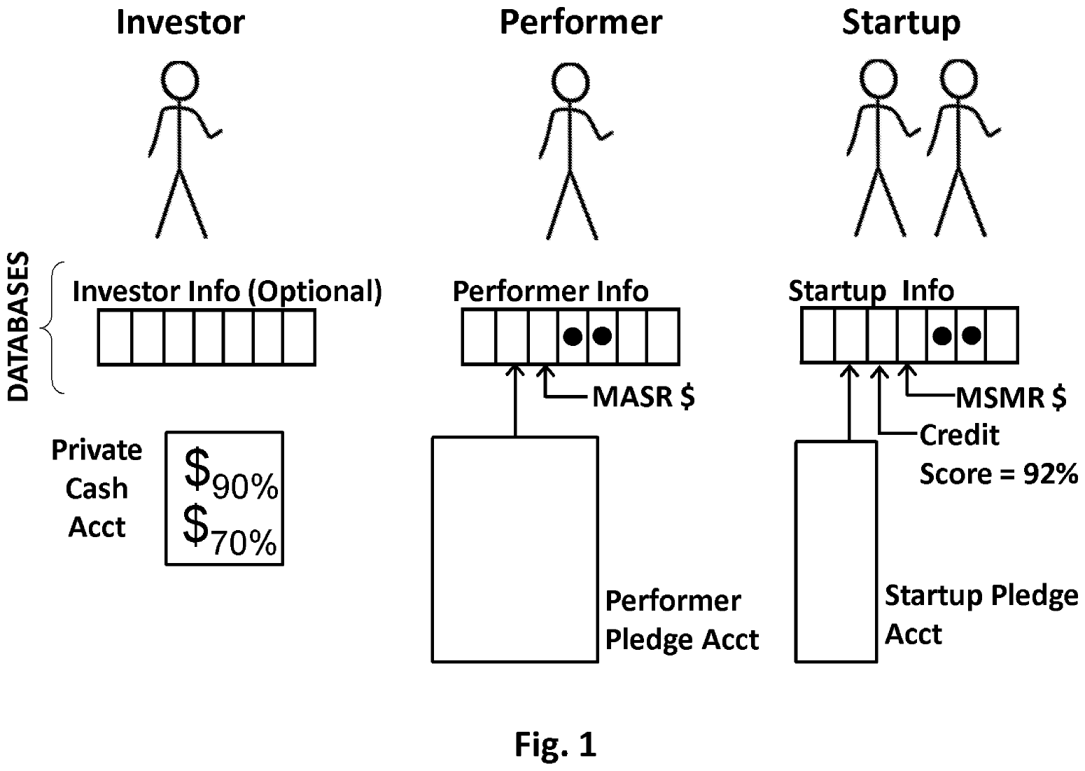

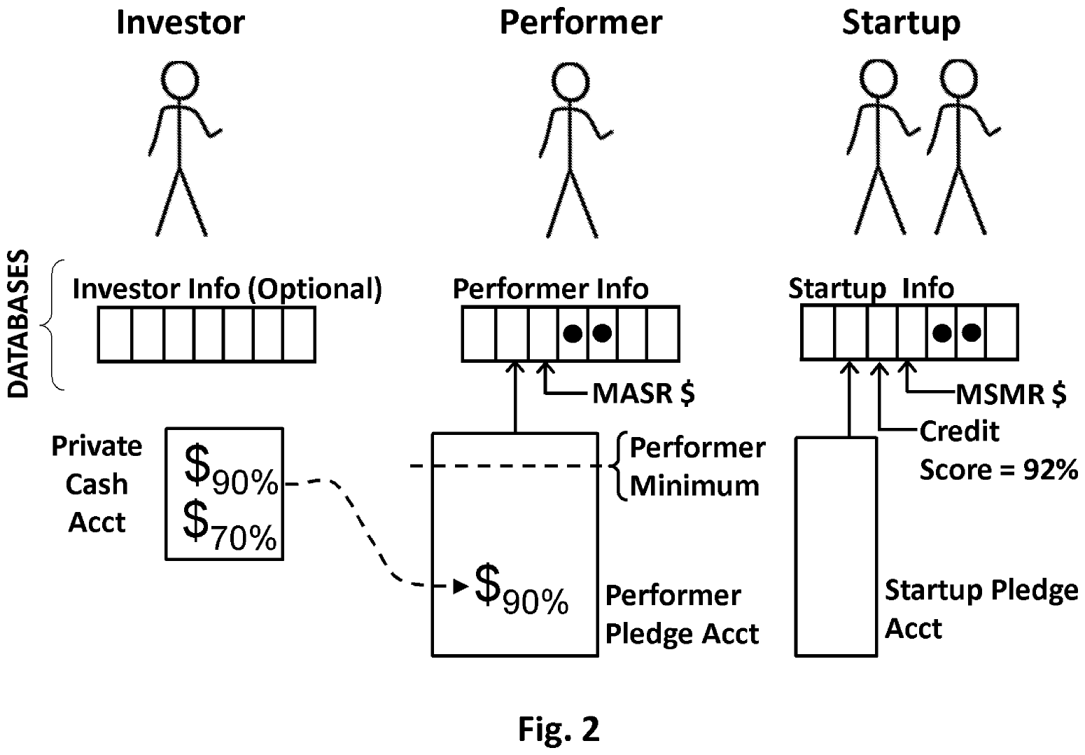

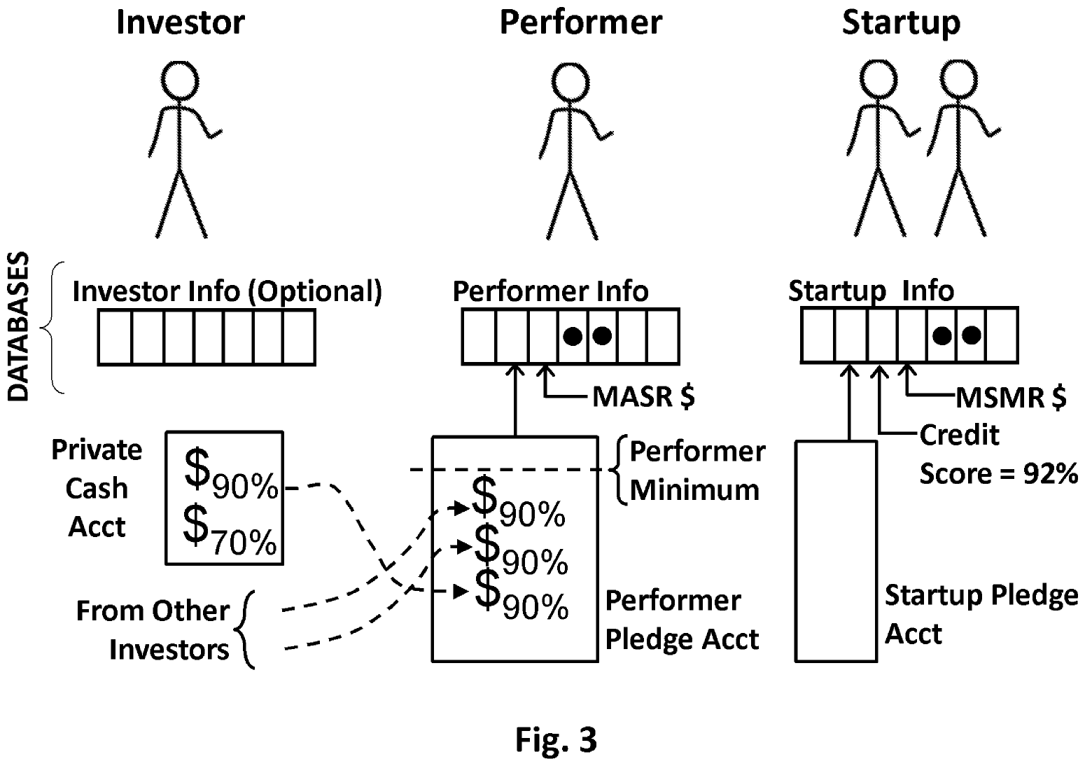

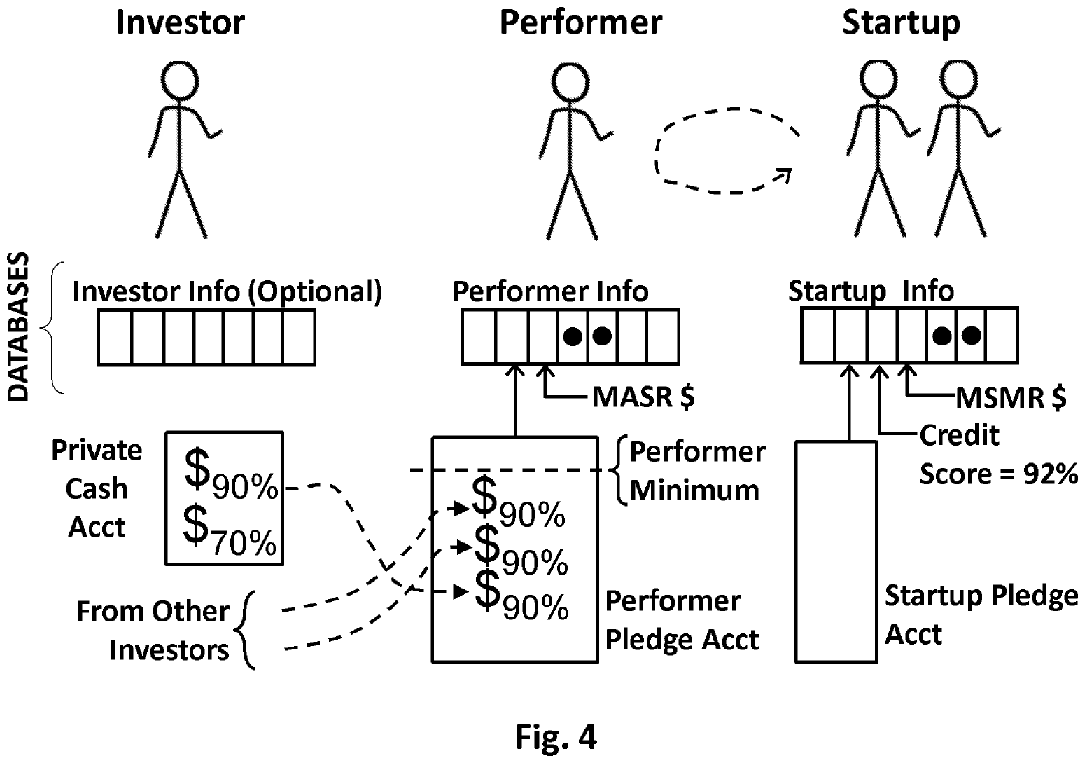

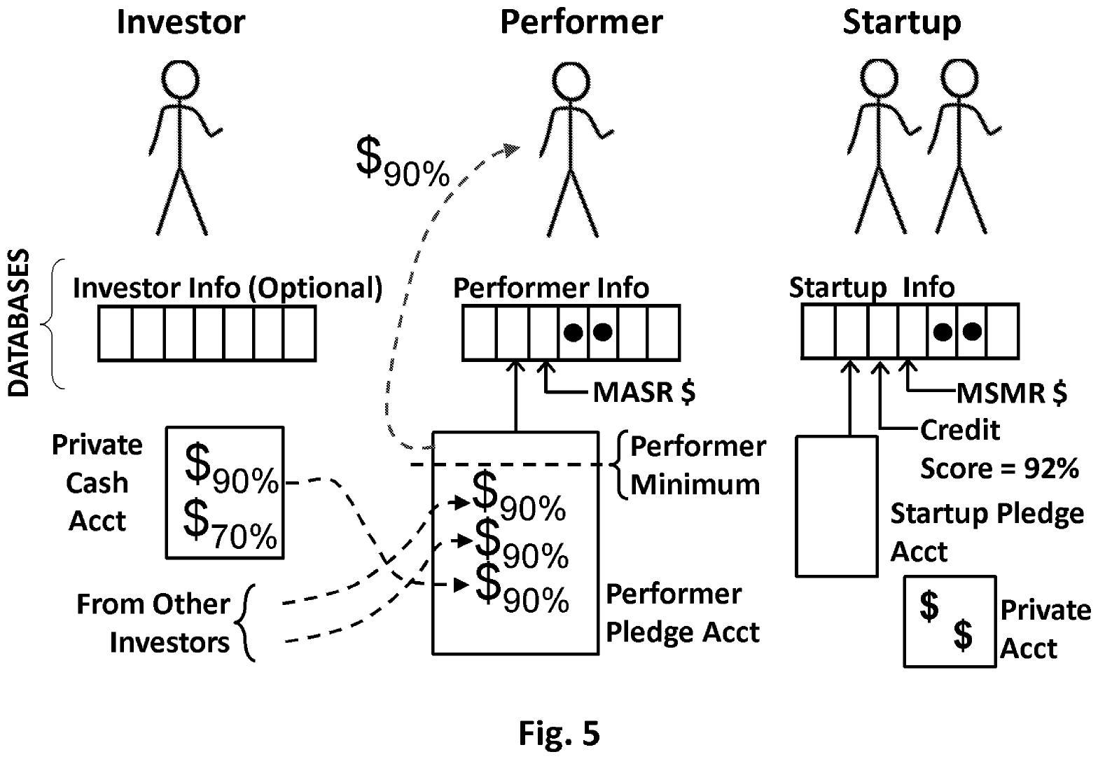

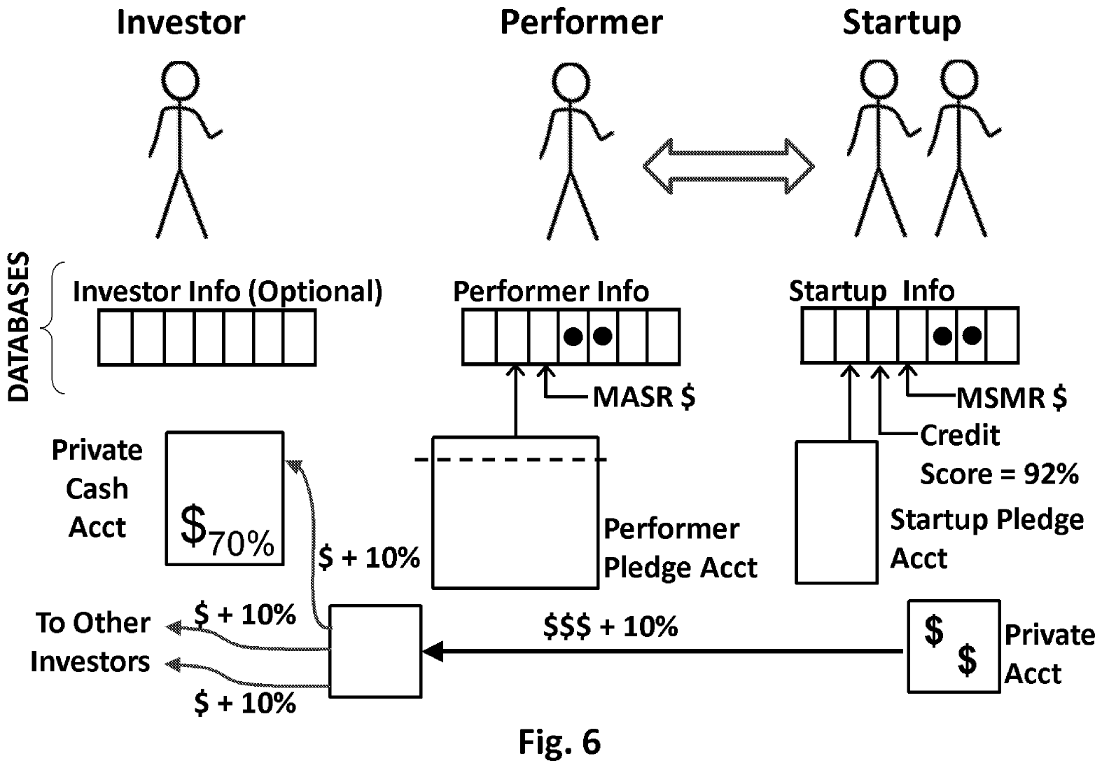

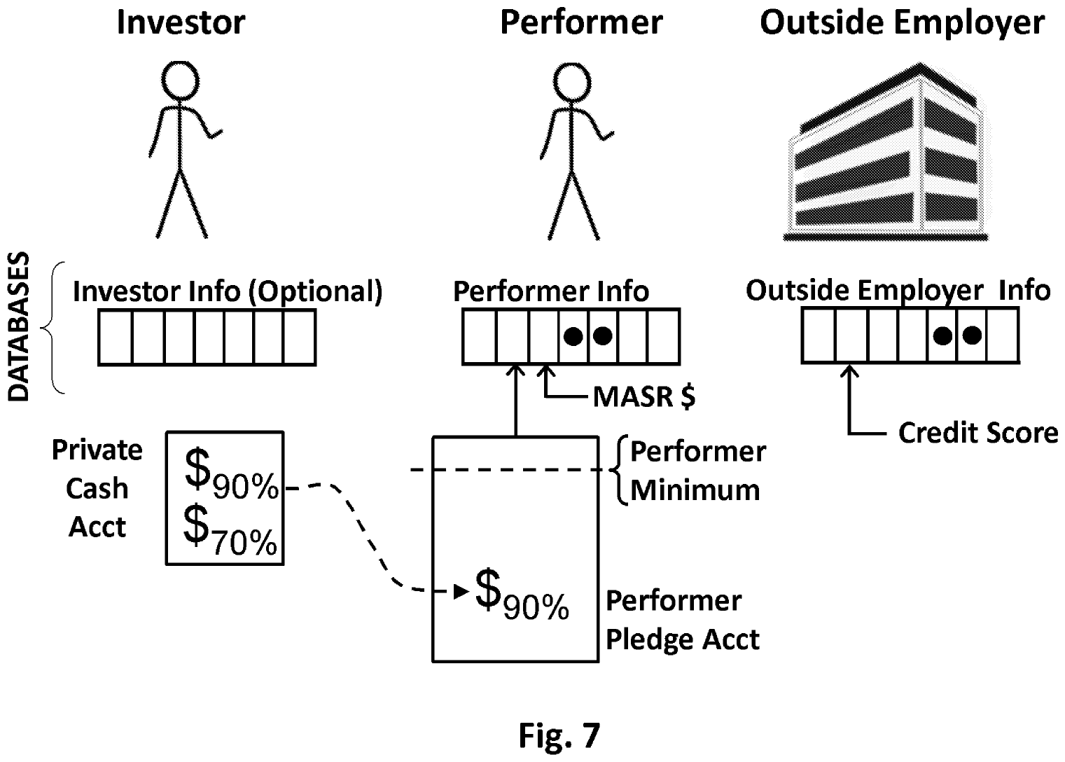

FIG. 1 is a diagram of an exemplary embodiment of the system in a basic form to illustrate the process with respect to a performer, that is, an individual who is a potential employee or contractor who is seeking a paying position with an employer. Exemplary aspects of the process are shown in FIG. 2-7. In this example, the employer is a startup company. The system includes a performer database, which is populated with performer data that employers and investors can see when deciding whether to commit funds or potential employment. The performer data includes data necessary for employers and investors to make these decisions, such as data related to the job description for the position the performer is seeking, the employment term the performer is seeking, and/or the minimum salary or pay rate that the performer will accept. The performer data can also include data related to work history, education, training, credentials, licenses, certifications, geographical area, and/or available equipment of the individual performer. In short, any information that is likely to be used by an employer to make a hiring decision, or by an investor to make an investment in the performer, can be included in the performer data.

Likewise, an employer database is also provided and populated with data related to available positions available for performers and the credit rating or credit risk score of an individual employer. Preferably, the credit rating or risk score is provided by a neutral third party.

A performer pledge account is also created and assigned to the individual performer. Investors who review the performer data and want to invest in the performer may pledge money to the performer pledge account. The pledge account preferably is an actual fund depository, such as a bank account, and funds are preferably pledged by depositing the pledged funds in the account. If the account is an interest-bearing account, the investor will accrue interest on the pledged funds while they are in the pledge account. The amount that is pledged can be the entire payment to the performer (salary or pay rate times the employment term), or can be just a portion of the funds required to pay the performer for the job. If the performer is bidding multiple jobs, several pledge accounts can be set up. If an investor pledges only a portion of the funds needed to satisfy the performer's requirements, other investors may also pledge funds to the same pledge account until the necessary funding has been reached. Once the funding to fulfill the performer's minimum salary or pay rate for the entire employment term has been reached, an employer can hire the employee.

Either the performer or an employer may associate the pledge account with a particular position looking to be filled by the employer. When the funds pledged to the pledge account reach the necessary funding amount, the employer can hire the performer. Preferably, before the hiring takes place, the funding and employment must be confirmed. The pledge account can be monitored by the performer and/or employer, and employment can be confirmed by the employer when the necessary funding has been reached. Alternatively, funding and employment of the performer by the employer can be confirmed automatically when the funds pledged by all investors reach the minimum salary for the employment term. Preferably, however, employment of the performer by the employer is confirmed by mutual assent of the performer, employer, and investors when the pledged funds reach the minimum salary.

Because the pledge account is a bank account, albeit a special purpose account that can handle multiple depositors, until the time that employment is confirmed, the investors are allowed to withdraw the pledged funds from the performer pledge account. At that time, accrued interest may be withdrawn as well. An administrator of the system of the invention can have responsibility of the pledge account and accounting for deposits, withdrawals, and payments to the performer. Once employment is confirmed and the performer is hired by the employer, the performer's salary is paid to the performer from the performer pledge account. In this way, the investor is guaranteed that pledged funds will be paid directly to the performer and will not be used by the employer for any other purpose. The manner and timing of payment can vary. For example, the performer's salary can be paid in periodic increments as agreed among the parties. One or more reports regarding the performer's employment preferably are prepared and provided to the investor, as a way of overseeing the performance of the investment. The system of the invention can include processes for termination of employment of the performer if the work product is not satisfactory, for example against predetermined standards, benchmarks, or time schedules. Otherwise, the salary is paid from the pledge account for the duration of the employment term. The investment amount, whether a fixed fee or a percentage of the pledged amount, will be paid to the investor by the employer. This amount will be paid in periodic increments, or in a lump at the end of the employment term, or as otherwise agreed by the parties.

When pledging funds to pledge accounts, an investor may “color” his or her pledge by conditioning the pledge based on items of the performer data, or based on employer's data, such as the credit rating or credit risk score. For example, the investor may color his pledge by assigning a minimum employer credit rating to the pledge. Any performer pledge account associated with employment for an employer having a credit rating or risk score that is lower than the minimum set by the investor would not be eligible for a pledge by that investor. In this way, an investor looking to spread investment funds among a number of performer pledge accounts would filter out undesirable candidates by coloring the pledge. Any other performer or employer data may be used to color pledges in this manner. Investors may also color their pledges to startup pledge accounts, which are described below.

Although the system provides advantages to any type of employer, it is particularly advantageous to a startup company, which might not have the assets required to assemble the initial workforce necessary to enter the market, or to an established company that is looking to expand but likewise lacks resources. Money pledged by investors to performer pledge accounts and used to pay the performers overcomes this problem. However, under the system of the invention, an employer can also have a pledge account, so that investors can pledge funds directly to an account that is associated with an employer rather than with a performer. Similarly to the performer pledge account, the employer pledge account can have certain information associated with it, such as a minimum funding amount, an investor interest rate, and/or a risk assessment score. As with the performer pledge accounts, investors may pledge the full minimum funding amount, or a portion of the amount. Employer pledge accounts can be committed to any expenditure specified by the employer seeking funding, such as to buy raw materials, to purchase inventory, or to be used to build a new factory. Investors are also able to color their pledges to the employer pledge account. The pledge account can also be restricted such that the funds can only be used for limited purposes. Once an employer pledge account is fully funded, confirmation is required before funds can be paid from the account to the employer. Typically, a contract with the bank managing the pledge accounts will govern the procedure for holding and distributing pledge funds and paying interest, and other contracts will control payment of investment proceeds.

Thus, the system of the invention generally includes a number of performer databases, performer pledge accounts, employer databases, and employer pledge accounts. Each performer database and pledge account is associated with a respective individual performer, who may have more than one pledge account corresponding to different employment positions he or she is seeking. Each employer database and pledge account is associated with a respective employer. Investors may pledge funds to any number of performer pledge accounts and employer pledge accounts, earning interest from the affiliated bank while the funds are in these accounts prior to confirmation of full funding of an account. After confirmation, performers are hired, salaries are paid out of the pledge accounts, and investment returns are paid from employers to investors. People are employed, business grows, and discretionary funds increase. The system of the invention makes possible the successful matching of investors, employers, and performers for the benefit of all participants. The novel manner of bringing all the parties together streamlines the process and provides quicker connections.

Preferably, investors, employers, and performers must register as members to make use of the system. Restricting participation to members gives those members a feeling of confidence that the provided information will remain confidential within the membership, so that they will feel free to provide that information. This in turn allows the sharing of most or all information within the membership, enabling transparency that leads to efficiency and corrections within the closed market. Information related to the pledged monetary funds, the salaries, the performer data, and the credit ratings are made available to members of the organization, all of whom can adjust their expectations and therefore their listed requirements according to market forces manifested it) the group data.

As the membership organization grows, information of members will become valuable to outside entities. Therefore, according to certain embodiments of the system of the invention, certain entities may be allowed to access at least some of the data of the members, either through purchasing access, or by becoming limited members of the system. For example, some of these entities could be granted access to performer data and employer data without identification of the particular performers and employers. Alternatively, these entities might be given access only to aggregate data on the performance of the system according to business field, profession, or other category. For example, an entity could be given access to data related to employment in the construction industry, to determined trends in salary for skilled workers in that field. As another example, an entity might be interested in access to data regarding recent growth in IT industry demand in a particular geographic region. Administrators of the system can charge fees to the outside entities for access to particular data of this sort, or for limited memberships to allow free access to limited categories of data.

An example of a nonparticipant limited member is a software developer who would develop software built on top of the core system software/algorithms. The software, some created by independent entrepreneurs, will sift through the system databases (enjoying the fruit of the algorithms that fed those databases), to build statistical views, predict future investment success, performer success, startup success, etc. This essentially adds “intelligence” for all the member participants.

The added software, built by others external to the system, serves as middleware that interface to the lower level system APIs for ease of access the system databases. The result is that this higher-level software is customized to generate information value for consumption by specific industries or consumers. This software is available for sale by parties external to the system. Of course, the users of the software may be, required to pay an access fee, depending on the scope of the resulting searches.

Thus, the main participants in the system are performers (job seekers), investors, and employers, which can be startups or other outside employers. In the most basic case, performers seek employment as an employee or a contractor, and investors pledge money to the performers. A performer joins the system as a member, preferably by creating a free account, although a fee could be required. The performer then provides relevant data, such as by uploading his resume/CV, and setting his minimum annual salary requirement (MASR) and minimum employment period to the system application. This application can be resident on the system server, with a corresponding client application loaded on the performer's computer or mobile device.

In a preferred embodiment, performers enter their attributes into an on-line form, and an automated tool reads their resumes and pre-populates the system data fields. The data fields preferably are extensive and can include such information as occupation, number of years of experience, credentials, licenses, certifications, education, any equipment or infrastructure or proprietary information they are supplying or lending to make their employment attractive (for example, personal car, truck, laptop with licensed software (CAD, Matlab, etc.), customer lists, intellectual property), and their geographical restrictions. Each performer would also enter a minimum annual salary requirement (MASR).

Performers who upload their resumes and MASR numbers are initially assigned a pledge account with a zero balance in it. Once the pledge account is established, an investor can see the account and may make a pledge of funds to the performer account. There is no limit to the pledge amount that an investor may pledge other than the investor's availability of funds.

As mentioned above, an investor may “color” his pledge money, that is, may require that the investment funds be restricted in some way, such as only to startups or other employers that meet a minimum credit score, to be able to commit his pledged money. This coloration of pledge money can apply to investor pledges to performers as well as investor pledges to startups.

The system of the invention, which includes databases, algorithms, and performer/employer engagement procedures, is designed to reduce the risk for all participants. To this end, the investor's “Color of Money” assignment sets the investor's risk level; a Color of Money=0 indicates that the investor is willing to take the maximum risk, while a “Color of Money”=1, or 100%, means that the investor wants zero risk. The risk level for a startup or outside company is set by one or more neutral risk assessors. If the investor keeps her Color of Money at 1, this implies that it will never be pledged and instead sits in her cash account earning interest only.

The minimum credit score for employers can include the principal's credit scores as well as the credit score of the business entity, shown individually or as a weighted average of all the credit scores applicable to the employer. Employers may decline to reveal their credit scores, but in those cases almost certainly will find lack of interest from investors and performers without the means to reliably judge risk.

### Example 1

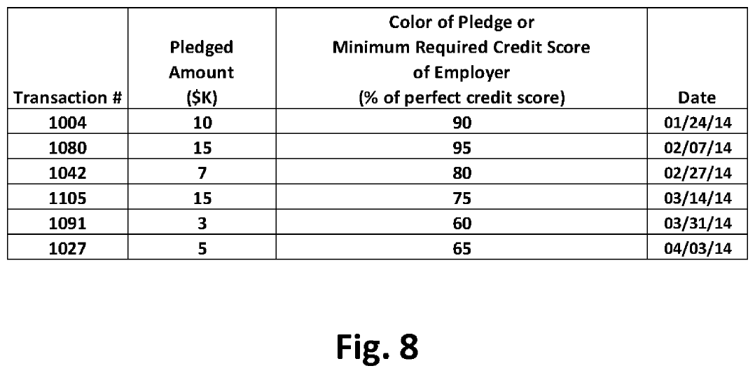

This example shows the interaction among investors, a performer, and a startup in the context of the performer's pledge account, in this example, the performer is an unlicensed plumber's apprentice who has an MASR of $30,000, and a minimum employment period of 12 months, and therefore the performer's minimum pledge amount is $30,000. A number of investors have made pledges with different colors of money as shown in FIG. 8.

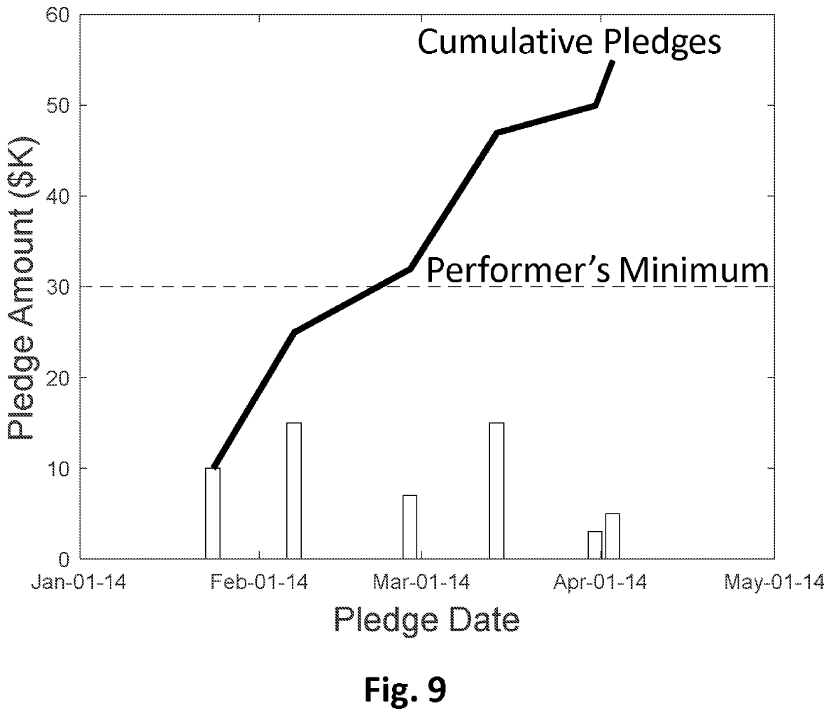

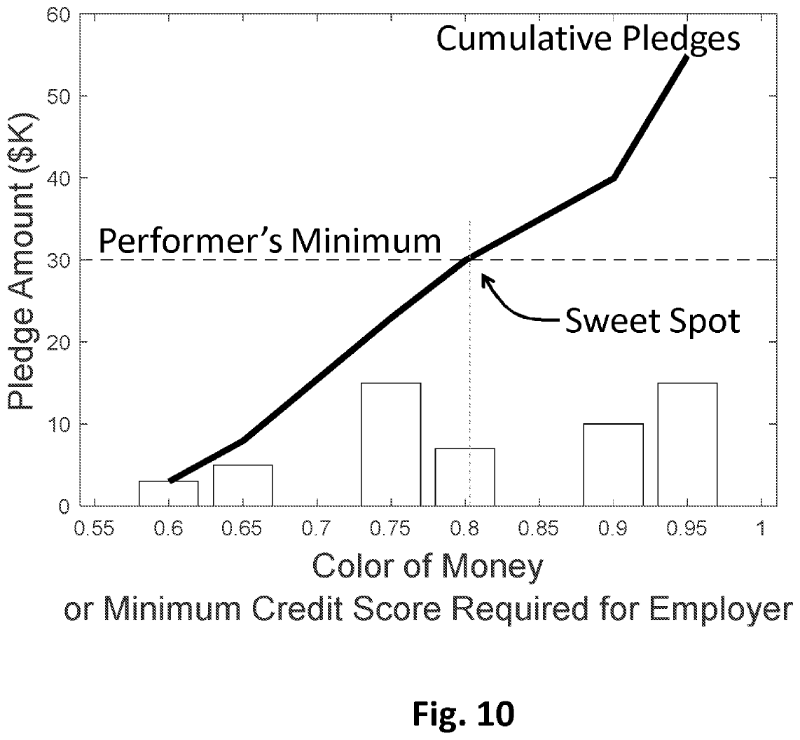

As shown, Investor #1091 pledged $3K and requires the employer to have a minimum credit score of 60% of a perfect score. Investor ID #1080 pledged a greater amount, $15K, but also requires a higher minimum credit score for the potential employer of 95%. The pledges of the other investors vary as shown. The system can show all the investor pledges as a function of time as well as a function of the “color of money” or “color of pledge.” For example, graphs such as those shown in FIGS. 9 and 10 can be made available for all member users to see and use.

It is apparent that the investor who colors his money with a minimum credit score of 90% does not need to study these graphs. Instead, the investor just colors his money (assigns a minimum credit score for the employer who wants to use the deferred labor charge) and the system does the rest automatically. Potential employers call see (via automated tools or by inspection of the graphs) that they need to have a minimum credit score of 90% or greater to convert the $30K of Investor pledges from an uncommitted status to a committed status.

If many investors pledge to the same pledge account such that the account is more than filled, different procedures can be used to assign and commit the available pledges. For example, according to an exemplary embodiment, once a pledge account is fully pledged and committed at the performer's minimum, the pledges that are actually committed are assigned from left to right on the Color of Money index, that is, the committed pledges with the lowest Color of Money are committed first and continue in ascending order of Color of Money until the performer's minimum is reached at the “Sweet Spot.” This method of assigning pledges encourages the investors to color their pledge money at the lower end, as the market demand for the services of performers will dictate the degree of risk the average investor will be willing to take on. Investors can also be encouraged to pledge early by prioritizing pledges chronologically if they are at the same level.

Investors can decide to add or remove money from uncommitted pledge accounts. If a pledge account that has received an investor's pledge is stable and is not changing over time, then the investors who have made pledges above the 80% minimum credit score level, for the above example, might think about removing their pledges and placing them elsewhere, such as with a performer who is attracting more recent interest and might be closer to reaching the minimum pledge funding and therefore closer to maturing as an investment. Likewise, a stagnant pledge account might cause the performer to lower the minimum funding requirement. Thus, market forces work within the system, causing participants to adapt.

Pledged investor funds can sit indefinitely in a pledge account until the funds are committed. After a certain amount of time, however, an uncommitted performer could withdraw the pledge account, or an automatic time period can be set up so that an uncommitted pledge account can “time out” In such cases, investors who do not get their pledged funds committed have their funds automatically returned, such as to an investor's cash account. The system of the invention allows investors to set up their own rules in this regard, based on any of the system database information, as to how and when their funds should be allocated to and dc-allocated from performer pledge accounts.

### Example 2

A plumber's apprentice has an MASR of $36K, and a minimum employment period of 6 months, so the “Performer's Minimum” for the plumber's apprentice is $18K. The default state of the performer's pledge account is “uncommitted,” As noted above, the investor is free to withdraw his pledge uncommitted pledge accounts or move it to a different performer's pledge account. The performer's pledge account becomes committed in this example on the occurrence of all of the following:
1. The employer decides to exercise a deferred labor charge, that is, the pledged MASR amount. The deferred labor charge is essentially a balloon loan at a predetermined interest rate with no prepayment penalty.
2. The investor's minimum criteria for the entity are met. The criteria will likely include a minimum credit score for the entity. That is, the employer has an aggregate credit score that is greater than or equal to the sweet spot on the cumulative pledge amount versus the minimum credit score graph.
3. The pledged total reaches the performer's minimum on the cumulative pledge amount versus minimum credit score graph, that is, the sweet spot.
4. The employer and the performer have reached an agreement with a starting date and employment period meeting the performer's minimum employment period.
5. Both the employer and the Performer have updated their system entries reflecting their mutual agreement. This serves as a locking mechanism that can be unlocked or broken by either party to make the pledge account change state from Committed to Uncommitted.

If the performer's pledge account changes state from Committed to Uncommitted, then the investors who had committed funds are now free to withdraw their pledge amounts. This serves as an incentive to keep the performer and startup honoring their commitments to each other.

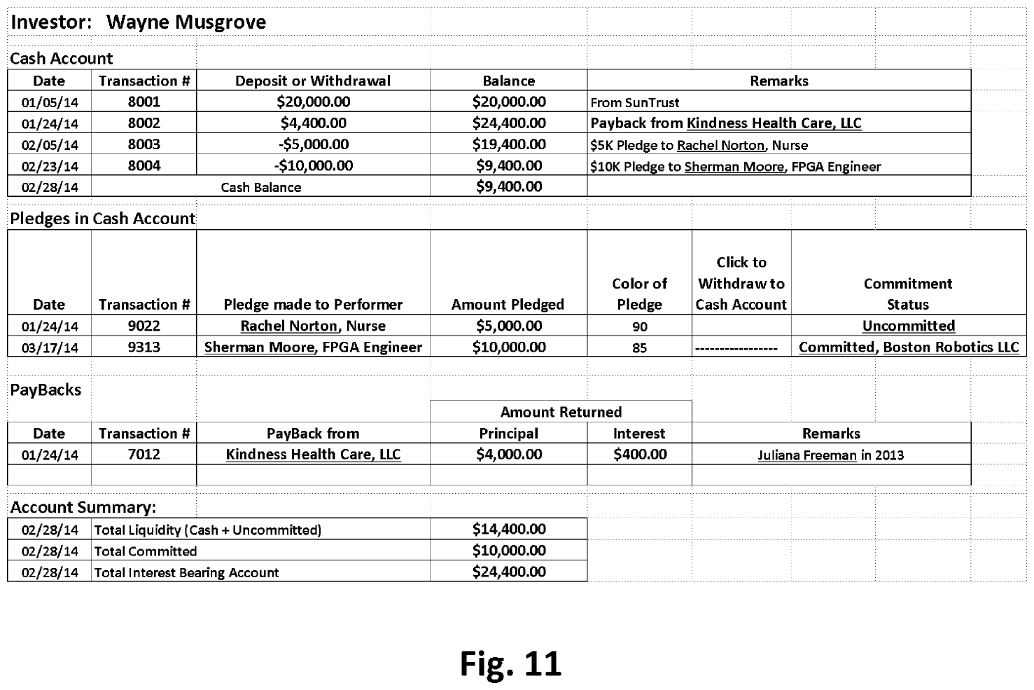

As noted above, a pledge is a transfer of money from the investor's cash account into the performer's pledge account, where it resides, earning interest for the investor, until the pledge is committed. From the investor's viewpoint, the uncommitted pledges are still owned by the Investor and are liquid. Thus the investor's view of his own system account can look as shown in FIG. 11.

It is notable that the investor can withdraw his uncommitted pledge from the performer's pledge account. If he were to do that, then the money would transfer and show up in his cash account. In a preferred embodiment, this can be performed through the use of a system application. In this embodiment, hyperlinked fields in the investor's on-line account statement allow the investor to drill down to see details of the performer or employer.

The following is a description of an exemplary mechanism for performer payment. At the end of each pay-period (which is set and agreed upon by both the performer and employer and is entered in their respective system database fields), the appropriate amount of money is transferred from the performer's pledge account to the performer's private cash account. If either the performer or employer is not satisfied with the other to the extent of termination of the business arrangement, they both mark their system database fields appropriately and payments to the performer will terminate. If serious disagreements arise, either party may break the commitment status, in which case the performer's pledge account returns to the Uncommitted state.

According to the system of the invention, investors may make pledges to, for example, individual performers, groups of performers, a single startup, or groups of startups. Investors may reduce their risk by securitizing their money across groups of performers or startups that meet criteria set by the investors. The criteria are implemented by culling the system databases, in effect setting filters for the distribution of the investor's pledge money.

### Example 3

An investor wants to spread a $5000 pledge uniformly across all performers who meet the following criteria:
seeking work as an eldercare aide,
having 1+ years of elder care or geriatric nursing experience,
willing to work in Tampa, Florida,
having an associate or higher degree,
having a MASR of <$30K/year, and
having a minimum employment period of 1 year.

This investor is exploiting her knowledge that there is an acute shortage of elder care aides willing to work for <$30K/year in the Tampa, Florida area. Applying the criteria as a filter across the performer population in the system, the investor's money can be pledged as a distribution to all performer pledge accounts that are not filtered out.

The system constitutes a marketplace, similar to the stock market, for both labor and startups. It is accessible by both Institutional investors (for example, Fidelity or Vanguard) as well as individual investors. It is accessible by aggregators and others who want to apply their own statistical and machine-learning tools to sell information to potential investors (both individual and institutional).

Investors can also pledge a certain amount of funds towards a single startup or group of startups. The startup in this case has a minimum seed money requirement (MSMR). If all the pledges for a particular startup exceed the MSMR and the investor's Color of Money (minimum required credit score for the startup) then that startup advances to the funded startup pool, that is, the startup's pledge account status changes from uncommitted to committed.

The system provides full transparency. Any full member (startups, funded startups, outside employers, etc.) may directly access any of the databases. Entities outside of the system, such as outside employers, may be made to pay a fee (lump and/or recurring) for access to the system databases.

Preferably, any performer is free to seek employment from anyone, inside or outside of the system. Likewise, it is preferable that any Startup is free to seek loans from anyone, inside or outside of the system.

The interplay of investor pledges, the marketplace, and the performer's transition to employment can be realized in many ways.

### Example 4

The Performer is a professional soccer player who had recently retired but has decided to come out of retirement. He joins as a member of the system because he knows that by posting his availability on the system fie will obtain a lot of free publicity as well as effortlessly connect to his fans. He lists his MASR at $4M/year, with a t year minimum employment period. Shortly after his signing up, many of his fans and others flock to the system to make many small individual pledges to his MASR.

His fans want to feel a connection with him. Others simply want to bet on what they consider to be sure thing having a certain return on their investment and know, without further due diligence, that the investment risk is low. For this hypothetical example, all investors color their money at 0%, that is, they don't care what the credit score is of the entity that hires the soccer player and want the best chance of having their pledges assigned in employment as committed.

The sports media report his daily pledge amounts, which quickly reach and surpass the $4M performer's minimum. The pledge account has now also passed the sweet spot on the accumulated pledges versus color of money graph, so any entity can hire him. Some possible outcomes:
(a) With all the media hoopla about his return from retirement, there is some competition among many teams for his services. As a result, he was direct-hired (outside the system) by Team A at $6M/yr. Because Team A did not exercise the system's deferred labor charge (loan) option, all of the $4M investor pledges for the player are returned to the individual investors' system cash accounts. The player holds a news conference to thank his fans and others who made pledges to him.
(b) A new soccer team, Team B, was recently formed. Team 8 is like a startup, in the sense that it doesn't have much liquidity or borrowing capability. They would like to hire the player, but they just don't have the short-term liquidity needed to make payroll during the first six months at the player's expensive salary. After 6 months, with the popular player on board, they have estimated that with the increased revenue stream they would just about break even. With the player on the team for a full year, their calculations show that they would be highly profitable. The problem is that they don't have the liquidity to hire the player directly. They've already applied for loans through, conventional sources and have gotten turned down. Outside private investors are willing to lend some money to them, but only in exchange for a large guaranteed return and an ownership interest in the team. However, the team can hire the player via the system's deferred labor charge, which is essentially a balloon loan, for example at a 10% interest rate with no early pre-payment penalty. The team decides to hire the player according to the system's 1 year deferred labor charge. But the team is not a system member, they are an outside employer. So they decide to join the system as an outside employer for a yearly fee and submit the necessary paperwork (essentially the same loan application required for a US government Small Business Administration loan). They pay the system's neutral assessor to review the loan application, again for a fee. The neutral assessor reviews their loan application, reviews on-line databases of the principals, and assigns an initial credit scare of 90%. The team's credit score now appears in the system database.

In this case, all of the $4M investor pledges came with the restriction that the entity who wants to borrow the investor pledge money (equivalently exercising the deferred labor charge) must have a minimum 80% credit score. The team satisfies that requirement. Both the player and the team agree to contract via the system, and update their database entries to reflect that agreement and the terms. The player's pledge account now changes status from Uncommitted to Committed. The player's pledge account is used to make the biweekly payments to the player. Thus, for a full year the team is able to employ the player with deferred labor charges. At the end of 1 year, the team issues a payment of $4M+10% to the system. The system distributes the returned funds to the investors based on their pro rata share of the $4M pledge amount.

### Example 5

The performer is Steve Dickinson, a recent graduate from the University of Michigan who obtained a B.S. in economics and an MBA with 3.5/4.0 GPA. He is seeking an associate position for business development in the financial services industry. He has been unemployed since he graduated six months ago and is living with his parents in Lansing, Michigan. The job market is tight. He has tried other job-search sites, which has resulted in only two job interviews and no job offers. With nothing to lose, he signs up for a free membership account with the system of the invention and uploads his resume. He pauses when he sees the MASR (minimum annual salary requirement). He consults salary survey sites for hints at what he should be expecting; they report a median annual salary for his occupation at $56K. He also looks around on the system for other performers similar to him and finds that this former MBA classmate, Zachary, is also a member of the system and is also looking for a business development position. Zachary's MASR is listed at $56K. Based on this information, Steve decides to list his MASR at $56K also. Steve also copies Zachary's one year minimum employment period.

Steve observes that his pledge account is at $0, while Zachary's pledge account is just north of $4,500. Steve doesn't know what his pledge account is, but he does know that Zachary has more pledge money than he does. Steve reads about pledge accounts and the role of investors in the system, and realizes that Zachary's profile is more attractive than his to investors by having the $4,500 pledge total, even though it doesn't reach Zachary's $56K MASR. Steve clicks on Zachary's pledge account and sees the history of anonymized pledges by amounts and dates. He sees several $100 pledges and a large $4K pledge over the span of the last few weeks.

Steve doesn't have cash to fund his own pledge account. He tells his uncle Bob about the pledge account, and that Uncle Bob can make 10% on any money he invests in Steve if a startup or outside entity hires Steve with the deferred labor charge (balloon loan) option. In any event, Steve tells Uncle Bob that it will help make his profile look better to potential employers if he just pledges some money to him, even if it doesn't get confirmed, he'll earn interest on the pledge, and he can withdraw it at any time. Uncle Bob decides to pledge $5K to Steve's pledge account. Uncle Bob puts further restrictions on his pledge; he colors it at 80% and requires (by checking a box) that if Steve gets employment outside of the system, his pledge money will automatically return to his system cash account.

Some possible outcomes:
(a) Two weeks after his Uncle Bob's pledge, Steve still has not had any interest, so he lowers his MASR to $49.9K. Shortly after he does this, he gets an interview and is hired directly by an employer outside of the system. The employer found Steve's resume by culling the system database based on search criteria that included MASR. At that point. Steve's pledge account is still uncommitted, and Steve updates his database to indicate that he is now employed. At that point all of Uncle Bob's pledge money for Steve is automatically returned to Uncle Bob's cash account, plus interest.
(b) One week after Uncle Bob pledges his funds, Steve gets an interview from a startup. The startup found Steve's resume on another job site, not via the system. The startup then checked the system databases to compare Steve to others who have similar experience and MASRs, including Zachary. The startup decides to hire Steve directly. At that point all of Uncle Bob's pledge money for Steve is returned to Uncle Bob's cash account.
(c) One week after Uncle Bob pledges his funds, some investors hear that a large financial services company will be moving to Lansing, Michigan, to take advantage of the educated workforce and relatively high unemployment rate. The Investors read that the financial services company will be hiring one hundred employees, including four business development associates. The investors look through the system and find that Steve and Zachary are the top two candidates with the lowest MASRs. The investors put enough funds into the pledge accounts for Steve and Zachary so that they both meet their MASRs. Steve and Zachary have both heard about the financial services company and they both send resumes directly to the financial services company.

Meanwhile, the human resources department of the financial services company is screening applications and conducting interviews. As part of their due diligence, the HR department checks the system database because it includes the MASR and other information not normally found an job search sites. HR personnel pencil in the MASR on both Steve and Zachary's resumes and forward the resumes to hiring managers. The managers call in Steve and Zachary, first, given that they fit the criteria company wants, including the MASR. The moving costs in Lansing are higher than expected. The company decides to exercise the system deferred labor charge for 1 year for both Steve and Zachary (they hire each at $50K). The company joins the system as an outside employer, pays the necessary fees, and obtains a high credit score of 85%, satisfying the investor criteria. During their first year of employment by the company, Steve and Zachary are issued bi-weekly salary checks from their respective system pledge accounts. At the end of one year, the company pays back the investors the $100K+10%. In essence the company gained about $100K in working capital, which helped them accelerate their business.

Any of the startups are free to hire anyone they choose. If a startup decides to employ someone from the system performer pool, it may optionally choose to do so for up to the performer's minimum employment period, with deferred labor costs. Traditional outside employers are also able to access the performer databases for a small monthly fee. To contract with a performer listed in the system with the deferred labor cost clause, the outside employer must accept the system terms and legal agreements.

In a case in which the outside employer decides to do a traditional hire, that is, the employer does not want to pay the premium for the deferred labor cost, the pledges are not exercised for that performer, and are simply released back to the respective investors.

The exemplary system database has two key components, namely, the performer database and the startup, or more generally, employer, database. The databases are extensive, with user-selectable criteria for convenient viewing.

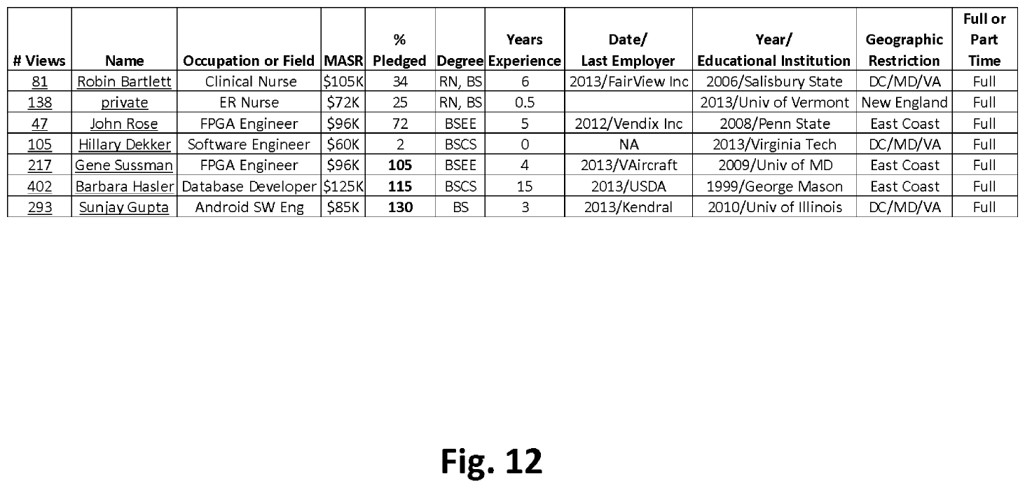

An illustrative example of a top level view of the performer database is shown in FIG. 12. When someone selects the hyperlink that is a performer's name, he or she can see the performer's database entries as well as summary information similar to that shown in FIGS. 8-10.

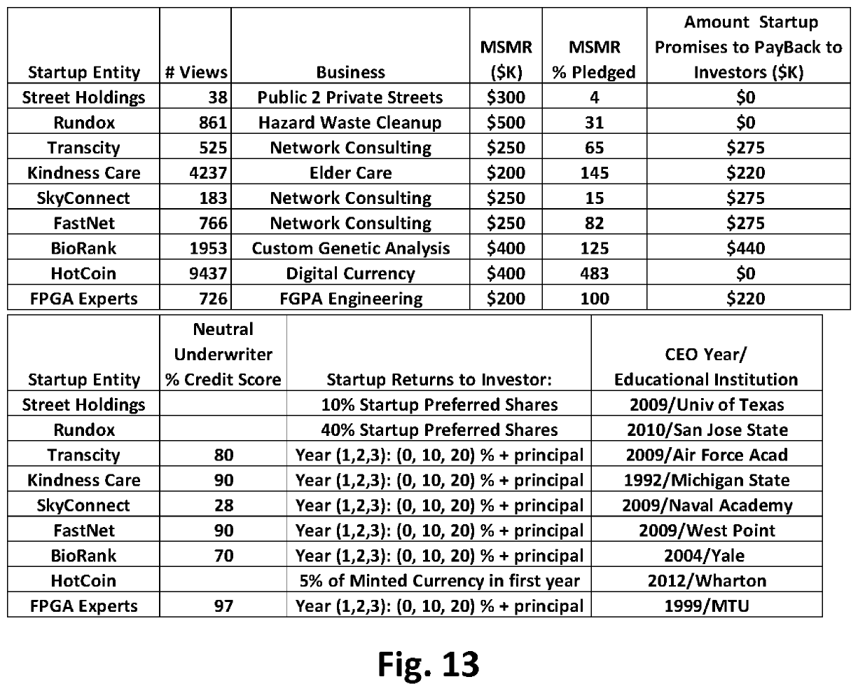

An illustrative example of a top level view of the startup database is shown in FIG. 13. Some of the dynamics showing the interaction among investors, performers, and startups (or outside employers) and other details are shown more clearly in FIGS. 2-7.

The system is attractive to investors, because investors who pledge money for a performer whose pledge account is subsequently committed (that is, a startup or outside employer contracts with the performer utilizing the performer's pledge account to defer the labor charge) obtain a predetermined investment return (a fixed fee or percentage rate of return). Investors who pledge money directly to a startup are agreeing to receive a return for their investment as specified by the startup in the startup's system database entry. If startup promises an interest payment, it might be interest paid on principal that is paid annually by the startup. For example, a startup might list schedule for a rate of return as follows:
Year 1: 0%
Year 2: 10%
Year 3: 20%+return of principal

But startup can promise something other than or in addition to cash. For examples, a startup can offer a percentage of startup preferred shares, or some units of product or services that the startup generates.

If the startup decides to contract with a system performer, it may choose to defer the labor cost using the performer's pledge account, assuming all the other criteria specified by the investors are met. At the end of contract or whenever the employment of that performer is terminated, whichever comes first, the startup pays back the investor principal plus the investment return.

Investors are informed up front that theft entire principal is at risk, and that there is no guarantee of return of principal or interest payments. Investors may minimize their risk by requiring that their pledged funds only go to startups that meet certain criteria, for example, a minimum credit score (calculated by a neutral risk assessor), and/or a minimum pledge amount that the startup will pay back to the investors. The same applies to an outside employer who wants to exercise the deferred labor cost for a funded performer. The outside employer must meet a minimum threshold (specified by the investor) on a certain metric. The metric might be projected cash available at the end of one year, operating expense ratio, or some other such quantity.

The past and present payback performance of startups, their principals, and outside employers who participate in the system, is publicly listed for all to see. The visibility and peer pressure help with weed out exploitive companies as well as ensure compliance. The system provides safety mechanisms by acting as the middle entity through which funds are distributed. As money is paid out from the system to the performer on behalf of the employer, the databases for all involved parties are updated with the specifics of each transaction. Thus, it is more difficult for unscrupulous startups to squander investor funds.

Automated algorithms monitor the system databases during the payout portion of the pledge cycle and provide updates to the investor. The databases are updated, for example, each pay period by the performer and employer with quantitative feedback about their self performance as well as their view of the other parties' performance. From the perspective of the performer or employer, the updates can be set to “auto” and “nominal” unless something goes awry. The transparency of these databases to investors, neutral risk assessors, others, statistical algorithms, and the like, also serve as a self-policing mechanism.

The neutral risk assessor performs a critical role for the system. All startups and outside employers are incentivized to obtain a credit score from the neutral risk assessor. The system requires that the investor's color of money be met by the startup or outside employer in order to commit a performer's pledge account, that is, use the performer's pledge account to pay the performer's wages. Still, a fraudster could set up a both a fake performer account and a fake startup account on the system. Investors would be attracted to the fake performer account based on its impressive credentials and would pledge money to it. The fraudster, acting as startup, could engage the fake performer to access the fake performer's pledge account. However, the fraudster realizes that fie needs to have a credit score assigned by a system neutral assessors, but the fraudster's fake startup is unable to get a credit score from the neutral assessor. The neutral assessor could only write into the fake startup credit score field that a credit score could not be computed. The investors who are connected to the fake startup via the fake performer's pledge account are notified that the risk could not be assessed. The pledge account never attains committed status, and the fraudster is blocked from the system.

The system is also attractive to performers, startups, and outside employers because the public display of the minimum annual salary requirement (MASR) for performers, and pledge history and amounts are keenly watched by everyone (performers, outside employers, and startups). As a result, a substantial amount of traffic is directed to the website, increasing the opportunities for everyone.

Also, performers and startups are not “locked in” to the system. If a performer is fully pledged, but the startup or employer wants to hire tier conventionally, then the parties may choose to contract for employment outside the system. In that case, the pledge amounts are not committed and the pledge money is returned to the investors. If a startup is pledged at the 100% level, but the startup obtains alternative (perhaps lower cost) financing, then the startup may choose not exercise the pledges, and the pledges are returned to the investor.

The system is also attractive to system administrators because of the traffic it will attract. The millions of unemployed persons are provided with a no-cost means to list themselves as performers with the system. Performers visit the system website frequently to watch their pledges accumulate, to adjust their minimum salary requirement (MASR) and minimum employment period, and to disclose additional information to make themselves look attractive to employers, all driven by market forces.

Startups are given access to both capital and skilled employees. The seed money interest rates will be set by the startups themselves and will typically be much lower than what venture capitalists charge. Startups visit the system site frequently to revise their interest rate offers in an effort to market themselves to potential investors.

Investors can invest in startups or individual performers with a small capital outlay and can select their rates of return from the startup offerings. Some of the investors of the individual performers are parents, relatives, and friends, further feeding the number of system page views.

Investors can reduce their risk by “securitizing” their pledges to a group of performers instead of just an individual performer. Investors can use any of the database criteria to select a group, for example, only those performers who have an R.N. degree, have one or more years of elder care or geriatric nursing experience, and are willing to work in Tampa. Florida.

System administrators make money by collecting a fee from the employer for every loan from an investor to an employer. Employers pay a fee to the system to join. The system also makes money by selling targeted advertising to investors and startups. The system preferably does not charge a fee for investments in individual performers, and individual performers preferably can join the system for free. The system can collect a fee based on the employer's interest payment to Investors.

The system attracts attention. Performers are competitive with their minimum salary requirement (MASR). People and employers outside of the system want to check the system to see what the market rates are for individual performers. There will be social competition on the pledge rates and pledge amounts relative to their peers. Parents and others will want to pledge some money so that their son or daughter doesn't show $0 in pledges, and to invest in their children's future while earning an investment return. The news media, economists, sociologists, and psychologists will want to study the trends on professions and individuals that get fully pledged or funded.

Many follow-on business opportunities naturally grow out of the system, including insurance, marketing, legal, accounting, and other services. The system will be an attractive target for buyout by a larger corporation lithe founders so choose.

The system employs modern machine-learning and statistical techniques so that the information presented to performers, startups, and investors are most relevant to each group.

The system model is responsive to high and low unemployment (as a whole or in a particular profession), because during high unemployment, employers will normally be flooded with resumes from performers. Employers want to exploit high unemployment to be both selective and undercut salary offers. In the system marketplace of individual performers, high unemployment will naturally cause performers to lower their MASR. The complement will occur during low unemployment.

On-line statistical tools show histograms and statistical information related to MASRs for a given profession. These on-line statistical tools, by themselves, are competitive with other employment statistic sites.

Performers have the option to set the period to become fully funded. A performer may change the fully funded period based or) market conditions to some other duration. Performers' personal information, such as name, address, and email address are, preferably by default anonymized and hidden from the public. Their MASR, past salary history, and other system database entries are publically accessible.

Likewise, investors' personal information, such as name, address, and email address) are, preferably by default, anonymized and bidden from the public. Their investments into a performer's pledge account are also anonymized.

Investors have the option of requiring that their pledge money only go to startups, or other entities, that have obtained a minimum credit score, set by the investor, from the neutral assessor. Under these circumstances, the pledge pool becomes tiered. For example, a group of investors requires a startup to have a minimum credit score of 90%, while a second group of investors is willing to take more risk, and require a startup to have a minimum credit score of 80%, If a startup gets an 85% credit score, then only the second group of investor pledges are eligible as a loan to the startup. The fully funded tiered levels are available for all to see in numerical and graphical form in the system database.

The system follows a maximum transparency philosophy. The neutral assessor will be numerically evaluated based on the success of his past projection performance. Preferably, the assessor's numerical score will be publically displayed. As pledges accumulate, anyone can click on the accumulated pledges for a performer, or a startup, and see the history of the pledges (date/time/amount), but not the name of the investors. This transparency will be generate excitement and arouse the curiosity of the performers, investors, and startups as everyone looks at everyone else's pledge drive history. The news media and groups that track employment statistics will be keenly observing and reporting on trends.

It is easy for a performer or investor or startup or outside employer to join the system. Preferably, automated software pre-populates database fields based on what is uploaded when joining the system.

Of course the MASR may be entered as $/year, or $/month, or $/week, or $/day, or $/hour, whatever is easiest for the performer.

Mutual funds and other institutional investors may also be registered investors as part of the system. This will further facilitate the flow of investment funds into the system. The institutional investors can offer a “select” fund that invests in performers meeting certain criteria. For example, an individual investor might think that the system is too complex to join as a member and invest directly, although he would want to be part of the system if it were easier. This investor can simply go to an institutional investor and invest in an offered “select” fund that participates in the system. The institutional investor does all the work for him.

Investors may withdraw their uncommitted pledge amounts at any time. A latency of withdrawals/transfers can be set up to prevent thrashing and high frequency trading exploitation of fund flows. Preferably, investment additions have the minimum possible latency.

Once a pledge amount is committed to a startup or outside employer, the investor's money is locked into the performer's pledge account. While it still resides in the committed pledge account, the investor continues to earn interest on it. If the performer and startup break up, then the performer's pledge account becomes uncommitted, and the investor may do whatever she wants with her money, such as move the funds from the performer's pledge account to a different performer's pledge account, or she can move it back to her private cash account.

A stock market of sorts is formed with the performer's pledge accounts, both uncommitted and committed. People may do calls, puts, buy, and sell their pledged amounts associated with a particular performer to others.

Investors earn interest on their money whether it is in their own cash account, or in a performer's pledge account.

Startups have the option to specify an amount that they will pledge to pay back to the investors (it may be any amount from $0 to their Minimum Seed Money Requirement). Startups also have the option to have a neutral assessor assign a numerical risk score to the amount they pledge to pay back to the Investors. Startup pay for this service.

Startups don't have to make a pledge to pay back investors nor do they have to obtain a numerical risk score. It is all a matter of market dynamics, if the startup has a great idea they may not need to pledge a single cent to pay back to the investors. On the other hand, if the startup is trying to get attention from investors, it could decide to pledge money back to the investors as well as obtain a numerical risk score from the neutral assessor.

Any changes that performers make to their MASR, employment status, or other information, are stored. This information is available on the system database and may be used by investors as a criterion for pledging when investing in a single performer or a group of performers. For example, an investor may only want to pledge to a group of performers whose MASR satisfies one of following constraints,
has not changed more than 5% in any 30-day period,
has not changed in the past 30 days,
has only decreased from the time the investor made her initial pledge, or
has only decreased from the time the investor made her initial pledge.

This allows an investor to have her pledge automatically withdrawn if certain criteria are met, for example, if a performer becomes employed, or cuts his MASR by 50%.

The system provides several automated predictive tools. One is based on the Myers Briggs personality test, to predict pairing success between performers and startups. Investors find the pairing success score helpful. The results of this prediction tool, and other predictive tools, are available for all to see.

The system provides translation of an investor's natural-language description of her investment criteria into database criteria. For example, the investor may state, “I want to invest $1000 to be spread across all performers who are currently unemployed and seeking a job as an elder care aide within 25 miles of Tampa, Florida, with the restriction that all of the money requires an employer to have a 90% credit score or better.” System tools translate these natural language investment criteria into database criteria, and then presents it to the investor for approval. Once approved, the system moves the money out of the investor's private cash account and spreads it across all the appropriate performers with the money colored at requiring 90% credit scores or better. This creates a pledge pool that further decreases the investor's risk. A simply command from the investor, equivalent to “Undo,” returns the funds from the distributed investor accounts to the investor's private accounts (assuming that none of the pledge accounts has changed from uncommitted status to committed status).

White there are many crowd funding sites for startups, none of them allow the startup to establish the terms for the rate of return on a loan. Further, no systems or sites are available in which individual performers have investors pledge funds for the future contract of performers, and have performers publically set and display their own minimum salary requirement (MASR).

The present invention has been described by way of example and in terms of preferred embodiments. However, it is to be understood that the present invention is not strictly limited to the particularly disclosed embodiments. To the contrary, various modifications, as well as similar arrangements, are included within the spirit and scope of the present invention. The scope of the appended claims, therefore, should be accorded the broadest possible interpretation so as to encompass all such modifications and similar arrangements.

I claim:

1. An employment investment process, comprising:
providing a performer database and populating the performer database with performer data, wherein the performer data includes data related to at least one of job description, employment term, and minimum salary of an individual performer;
providing an employer database and populating the employer database with data related to available position, intended projects, and credit rating of an individual employer;
assigning a performer pledge account to the individual performer;
enabling investors to pledge monetary funds to the performer pledge account;
employing the performer by the employer when the pledged monetary funds reach the minimum salary;
paying the performer's salary to the performer from the performer pledge account until the end of the employment term; and
paying an investment amount to the investors by the employer.

2. The process of claim 1, wherein the performer data includes data related to at least one of work history, education, training, credentials, licenses, certifications, geographical area, and available equipment of the individual performer.

3. The process of claim 1, further comprising conditioning the investor's pledge based on any one or more items of the performer data.

4. The process of claim 1, further comprising generating the credit rating of the individual employer by a third-party entity.

5. The process of claim 1, wherein the performer pledge account is associated with a depository of the pledged monetary funds.

6. The process of claim 5, further comprising depositing the pledged monetary funds into the depository by the investor at or after the time that the funds are pledged.

7. The process of claim 6, further comprising paying interest on the deposited pledged funds by an affiliated bank to the investor.

8. The process of claim 1, further comprising corresponding the individual performer's job description with the available position of the individual employer.

9. The process of claim 1, further comprising conditioning the investor's pledge based on the individual employer's credit rating.

10. The process of claim 9, wherein conditioning the investor's pledge includes assigning a minimum employer credit rating to any pledge of monetary funds.

11. The process of claim 1, further comprising monitoring the pledged funds until the minimum salary is reached.

12. The process of claim 11, further comprising confirming employment of the performer by the employer.

13. The process of claim 12, wherein employment of the performer by the employer is confirmed automatically when the funds pledged by all investors reach the minimum salary for the employment term.

14. The process of claim 12, wherein the employment of the performer by the employer is confirmed by assent of the performer, employer, and investors when the pledged funds reach the minimum salary.

15. The process of claim 14, further comprising allowing the investors to withdraw the pledged funds from the performer pledge account if the employment of the performer by the employee is not yet confirmed.

16. The process of claim 14, further comprising employing the performer by the employer after the employment is confirmed.

17. The process of claim 16, further comprising paying a salary to the performer from the performer pledge account.

18. The process of claim 17, wherein the performer's salary is paid in periodic increments.

19. The process of claim 16, further comprising preparing a report regarding the performer's employment and providing the report to the investor.

20. The process of claim 1, wherein the investment amount is paid to the investors by the employer at the end of the employment term.

21. The process of claim 1, wherein the investment amount is a predetermined percentage of the pledged monetary funds.

22. The process of claim 1, wherein the investment amount is a predetermined fixed monetary amount.

23. The process of claim 1, wherein the employer is one of a business startup and an outside employer.

24. The process of claim 23, further comprising assigning an employer pledge account to the employer.

25. The process of claim 24, further comprising associating at least one of a minimum funding amount, an investor interest rate, and a risk assessment score with the employer pledge account.

26. The process of claim 24, further comprising enabling investors to pledge monetary funds to the employer pledge account.

27. The process of claim 1, further comprising:
providing a plurality of the performer databases, wherein each said performer database is associated with a respective individual performer;
providing a plurality of the employer databases, wherein each said employer database is associated with a respective individual employer;
assigning a performer pledge account to each said individual performer;
enabling investors to pledge monetary funds to one or more of the performer pledge accounts;
employing one of the performers by one of the employers when the pledged monetary funds for the one performer reach the minimum salary associated with the one performer;
paying the one performer's salary from the performer pledge account until the end of the employment term; and
paying an investment amount to the investors by the one employer.

28. The process of claim 27, wherein enabling investors to pledge monetary funds to one or more of the performer pledge accounts includes enabling an investor to pledge the monetary funds such that the funds are distributed among a subset of the plurality of performers.

29. The process of claim 28, further comprising selecting the subset based at least in part on data included in the performer databases.

30. The process of claim 29, further comprising selecting the subset based at least in part on the credit ratings of plurality of employers.

31. The process of claim 27, further comprising:
offering membership to an organization to the performers, the investors, and the employers; and
restricting the process to the performers, the investors, and the employers who are members of the organization.

32. The process of claim 31, further comprising making at least some information related to the pledged monetary funds, the salaries, the performer data, and the credit ratings available to members of the organization.

33. The process of claim 32, further comprising allowing data users to become members of the organization, wherein the data users are not performers, investors, or employees.
